(19) United States
(12) Patent Application Publication
(10) Pub. No.: US 2010/0202475 A1
(43) Pub. Date: Aug. 12, 2010

(54) STORAGE DEVICE CONFIGURED TO TRANSMIT DATA VIA FIBRE CHANNEL LOOP

(75) Inventor: Shinichiro NAKAZUMI, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/761,838

(22) Filed: Apr. 16, 2010

Related U.S. Application Data
(63) Continuation of application No. PCT/JP2007/070327, filed on Oct. 18, 2007.

(51) Int. Cl. H04J 3/24

(52) U.S. Cl. 370/475

(57) ABSTRACT

According to one embodiment, an arbiter transmits its own arbitration signal from a port to a fibre channel loop in order to acquire a possessory right for the fibre channel loop when a data transmission request has occurred at the port. A detector detects a latency time from when its own arbitration signal is transmitted until the possessory right is acquired. A frame transmitter transmits a frame with a burst length corresponding to the detected latency time from the port to a destination via the fibre channel loop.

### CROSS-REFERENCE TO RELATED APPLICATIONS

This is a Continuation Application of PCT Application No. PCT/JP2007/070327, filed Oct. 18, 2007, which was published under PCT Article 21 (2) in Japanese.

### BACKGROUND

1. Field

One embodiment of the invention relates to a storage device, a transmission controller, and a method which transmit data in one direction via, for example, a fibre channel loop.

2. Description of the Related Art

In a conventional storage subsystem intended for, for example, servers, a large number of storage devices, such as magnetic disk drives, are connected through a fibre channel loop (hereinafter, referred to as an FC loop) under a control module connected to a server via a channel. As for FC loop interface standards (fibre channel standards), for example, the Fibre Channel Physical and Signaling Interface (FC-PH) was defined by the American National Standards Institute (ANSI) in 1994. FC-PH has been provided as X3.230. In addition, as an FC loop interface standard, the Fibre Channel Arbitrated Loop (FC-AL) was defined by ANSI in 1995.

An interface for connecting a device, such as a magnetic disk drive, to an FC loop is known as a port. To exchange information between a transmission-side device and a reception-side device, each of the transmission-side port and reception-side port has to acquire the right to occupy the FC loop (loop possessory right). A port which wants to access another port performs arbitration determined in the FC loop interface standard FC-AL to acquire the loop possessory right.

To prevent the possessory right to concentrate on a specific port, arbitration is performed according to an access fairness program. Therefore, the frequency at which each port can acquire the loop possessory right is equal. However, since the quantity of the information transmission after the loop is occupied differs from port to port, the individual ports are not equal in terms of loop occupation time.

FIG. 12 shows loop occupation times when the amount of data transmitted at a time from a first port (i.e., the quantity of one transmission at the first port) is small and the amount of data transmitted at a time from a second port (i.e., the quantity of one transmission at the second port) is large in a conventional FC loop. In FIG. 12, the first port and second port both have the same frequency of acquisition of loop possessory right. However, since the quantity of one transmission at the first port is small and the quantity of one transmission at the second port is large, the loop occupation time of the first port is as short as T1 and that of the second port is as long as T2. That is, the first and second ports are not equal in terms of loop occupation time. Accordingly, a port which wants to transfer a small amount of information is caused to wait for a longer time because of traffic to transmit a large amount of information at another port.

FIG. 13A is a timing chart to explain a state where, although a first port in a host has to issue a command to a third port in a device, the first port cannot issue the command because of interference from burst transmission at a second port in another device and is caused to wait. A small amount of traffic in a device, such as a magnetic disk drive, frequently includes important information for information exchange, such as commands, status, or data request frames. This is because the host receives a status frame from the device and issues a new command and the device receives the command from the host and starts to process the command. Furthermore, since the device can carry out an advance execution process, such as the reordering of commands, even during the time when another port is occupying the FC loop, transmitting a small amount of information as early as possible improves the throughput of the entire system. The reordering of commands is the function of reordering commands so as to make the processing time shorter.

FIG. 13B is a timing chart to explain a case where the occupation time of burst transmission at the second port is short. In the example of the timing chart shown in FIG. 13B, traffic at the second port of another device does not interfere with the issue of a command to the third port of the device from the first port of the host. In this state, even during the time when the second port is occupying the FC loop, the device can carry out such an advance process as the reordering of commands.

As described above, when the quantity of one transmission at each port in the FC loop is made smaller, the loop occupation time at each port becomes increasingly equal. However, if the quantity of one transmission decreases, data has to be divided for transmission. Since the loop is occupied and freed alternately in the divided data transmission, the overhead of the entire system increases.

For example, suppose the first port is only one port which wants to use the FC loop as shown in FIG. 14A. In this case, although the port of one other device does not occupy the FC loop because the one other device is in the idle state, the loop is occupied and freed alternately because of the divided data transmission. As a result, the overhead of the entire system increases. In such a case, if the data is transmitted at a burst without dividing the data as shown in FIG. 14B, the efficiency will increase.

The optimum data length (i.e., burst length) for burst transmission depends on the state of traffic on the FC loop. However, in the conventional data transmission (hereinafter, referred to as the conventional art) using the aforementioned FC loop, although the optimum burst length exists, a magnetic disk drive connected via a port to the FC loop always transmits data at a constant maximum burst length, the default burst length. Accordingly, the efficiency of the data transmission is low.

The default burst length (i.e., maximum burst length) at the magnetic disk drive can be changed by, for example, a mode select command. In the conventional art, however, only when the magnetic disk drive is started up, a burst length is initialized to the maximum burst length predetermined as a design parameter in accordance with a command. After the initialization, while the magnetic disk drive is in operation, the drive uses the initialized burst length. As described above, in the conventional art, the burst length used by the magnetic disk drive is constant, regardless of the traffic state of the FC loop. Accordingly, in the conventional art, it is difficult to transmit information using the FC loop efficiently with respect to various information transmission quantities at the individual ports.

Furthermore, in the conventional art, the interface of the FC loop does not function as a specific arbiter that manages traffic. Therefore, it is difficult for each port to recognize how much traffic there is on the FC loop and determine the optimum burst length according to the traffic state of the loop.

### BRIEF DESCRIPTION OF THE SEVERAL VIEWS OF THE DRAWINGS

A general architecture that implements various features of the invention will now be described with reference to the drawings. The drawings and their associated descriptions are provided to illustrate the embodiments of the invention and not to limit the scope of the invention.

FIG. 1 is a block diagram showing an exemplary configuration of a storage subsystem according to an embodiment of the invention;

FIG. 2 shows a basic configuration of an FC loop which connects magnetic disk drives to the device interfaces of FIG. 1;

FIG. 3 is a block diagram mainly showing an exemplary configuration of a magnetic drive applied in the embodiment;

FIG. 4 is a block diagram showing an exemplary configuration of the FC interface port and FC interface controller in the magnetic disk drive of FIG. 3;

FIGS. 5A and 5B show examples of a burst length setting table applied in the embodiment;

FIGS. 6A and 6B are time charts to explain an example of the relationship between latency times detected in the embodiment and burst transmission;

FIG. 7 shows an exemplary format of a frame transmitted via the FC loop;

FIG. 8 is a table listing exemplary primitive signals used in acquiring and freeing the loop possessory right;

FIG. 9 is a flowchart to explain the procedure for processing exemplary arbitration for the FC loop applied in the embodiment;

FIG. 10 is a flowchart to explain the procedure for processing exemplary fairness control applied in the embodiment;

FIG. 11A shows a schematic configuration of an FC loop corresponding to FIG. 2;

FIG. 11B shows an example of the evaluation result when the burst length was changed in accordance with the latency time on the FC loop shown in FIG. 11A;

FIG. 12 is a time chart showing the loop occupation times of ports in the conventional art;

FIG. 13A is a time chart showing a state where the first port is interfered with by burst transmission from the second port and cannot issue a command in the conventional art;

FIG. 13B is a time chart showing a state where the first port can issue a command without being interfered with by burst transmission from the second port in the conventional art;

FIG. 14A is a time chart in a case where data is divided and transmitted with the FC loop freed in the conventional art; and

FIG. 14B is a time chart in a case where data is not divided and is transmitted at a burst in the conventional art.

### DETAILED DESCRIPTION

Various embodiments according to the invention will be described hereinafter with reference to the accompanying drawings. In general, according to one embodiment of the invention, there is provided a storage device. The storage device comprises: a port configured to transmit data in one direction of a fibre channel loop; an arbiter configured to transmit its own arbitration signal from the port to the fibre channel loop in order to acquire a possessory right for the fibre channel loop when a data transmission request has occurred at the port; a detector configured to detect a latency time from when its own arbitration signal is transmitted until the possessory right is acquired; and a frame transmitter configured to transmit a frame with a burst length corresponding to the detected latency time from the port to a destination via the fibre channel loop.

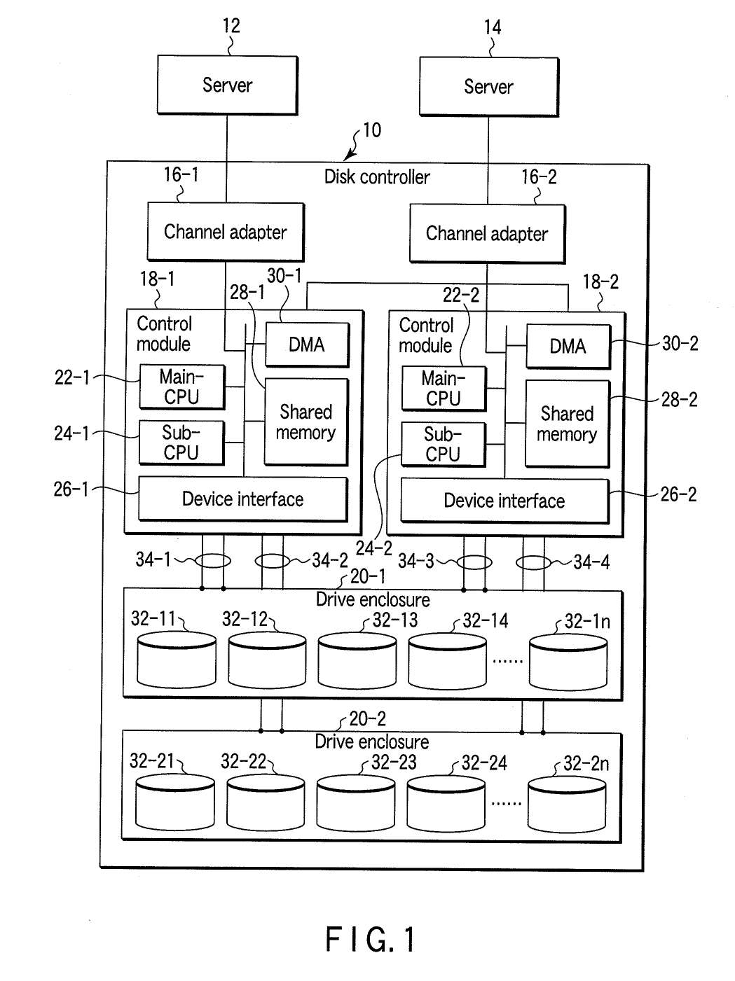

FIG. 1 is a block diagram showing the configuration of a storage subsystem according to an embodiment of the invention. In FIG. 1, a disk controller 10 comprises channel adapters 16-1 and 16-2, control modules 18-1 and 18-2, and drive enclosures 20-1 and 20-2. A global-type server 12 serving as a host device is connected to the disk controller 10 with, for example, the channel adapter 16-1. Moreover, an open-type server 14 serving as a host device is connected to the disk controller 10 with the channel adapter 16-2.

The control module 18-1 comprises a main-CPU 22-1, a sub-CPU 24-1, a device interface 26-1, a shared memory 28-1, and a direct memory access (DMA) module 30-1. The control module 18-2 comprises a main-CPU 22-2, a sub-CPU 24-2, a device interface 26-2, a shared memory 28-2, and a DMA module 30-2. Therefore, the control modules 18-1 and 18-2 have the same configuration. The drive enclosure 20-1 comprises magnetic disk drives 32-11 to 32-1n as storage devices. The drive enclosure 20-2 comprises magnetic disk drives 32-21 to 32-2n as storage devices.

Next, the configuration of the control modules 18-1 and 18-2 will be explained in detail, taking the control module 18-1 as an example. The control module 18-1 comprises two CPUs: a main-CPU 22-1 and a sub-CPU 24-1. This enables the control module 18-1 to virtually realize the same processing function as that of two control modules.

The control module 18-1 further comprises the shared memory 28-1 shared by the main-CPU 22-1 and sub-CPU 24-1. In the shared memory 28-1, an area used as a cache memory and an area to which a configuration table serving as a target of configuration management is to be allocated have been secured.

Between the device interface 26-1 and the drive enclosures 20-1 and 20-2, fibre channel loops (hereinafter, referred to as FC loops) 34-1 and 34-2 connected to the device interface 26-1 are provided. Magnetic disk drives 32-11 to 32-1n are connected to the FC loop 34-1. Magnetic disk drives 32-21 to 32-2n are connected to the FC loop 34-22.

Similarly, between the device interface 26-2 and the drive enclosures 20-1 and 20-2, FC loops 34-3 and 34-4 connected to the device interface 26-2 are provided. Magnetic disk drives 32-11 to 32-1n are connected to the FC loop 34-3. Magnetic disk drives 32-21 to 32-2n are connected to the FC loop 34-4.

If each of the FC loops 34-1 to 34-4 complies with the ANSI Fibre Channel standard (FC Loop Interface standard), a maximum of 126 ports can be connected to one loop. Accordingly, if one port is allocated to each of the device interfaces 26-1 and 26-2, a maximum of 125 magnetic disk drives can be connected to the remaining ports.

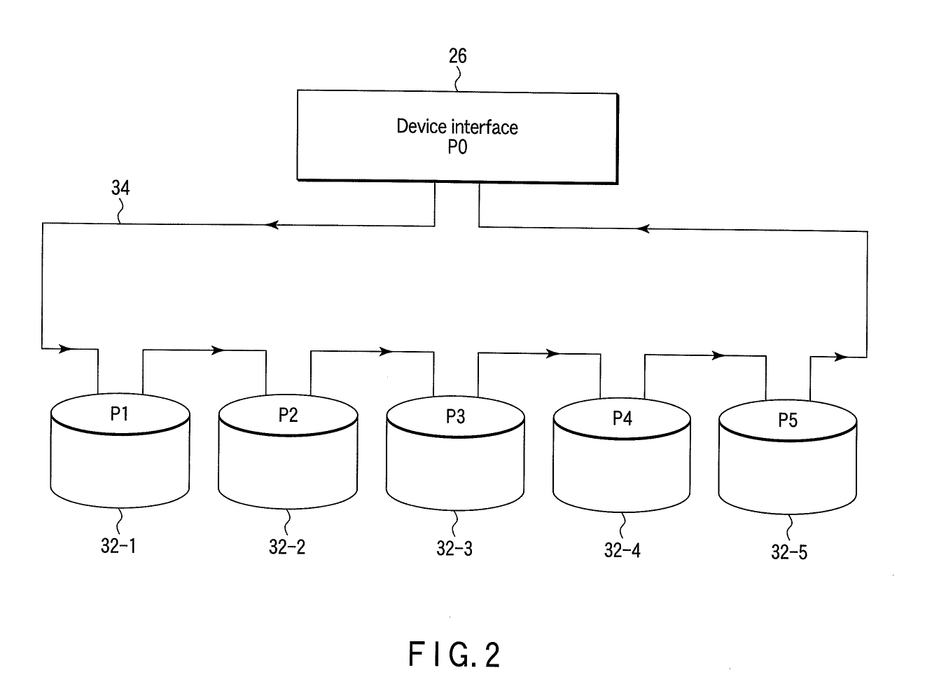

FIG. 2 shows a basic configuration of the FC loop which connects the magnetic disk drives to the device interface of FIG. 1. In FIG. 2, the FC loop 34 corresponds to each of the FC loops 34-1 to 34-4 shown in FIG. 1. The FC loop 34 is a high-speed data transmission network with transmission speeds of 1 gigabit per second (Gbps), 2 Gbps, and 4 Gbps. The FC loop 34 is an interface which has characteristics of a channel connection interface, such as the Small Computer System Interface (SCSI), and a network connection interface, such as Ethernet (registered trademark).

A main application of the FC loop 34 is a storage area network (SAN) as shown in the storage subsystem of FIG. 1. The FC-34 connects the group of servers by a switch network via the disk controller 10, providing solutions to use the storage resources efficiently.

In FIG. 2, not only the device interface 26 acting as the host side but also, for example, 5 magnetic disk drives 32-1 to 32-5 are connected via ports P1 to P5 to the FC loop 34, respectively. In FIG. 2, magnetic disk drive 32-5 corresponds to each of magnetic disk drives 32-1n and 32-n in FIG. 1.

When a data transmission request has occurred at a port connected to the FC loop 34, the port acquires the right to occupy the FC loop 34 according to FC-AL, the ANSI fibre channel standard, as described in detail later. Then, the source port transmits such information as a command frame, a status frame, a data request frame, or a data frame, in one direction according to the FC-PH standard in such a manner that the source port links with a destination port in a one-to-one correspondence.

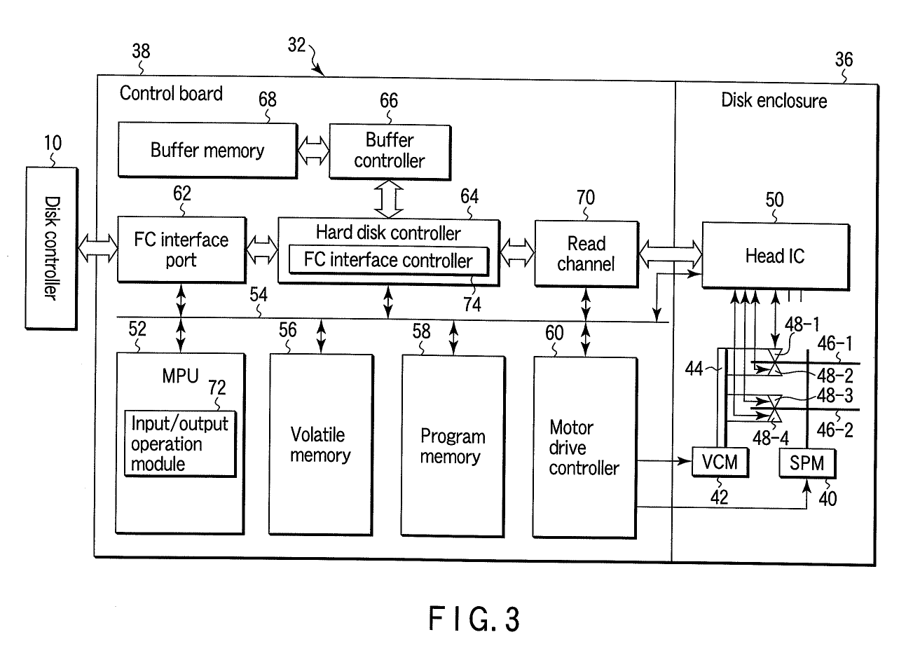

FIG. 3 is a block diagram showing the configuration of a magnetic disk drive applied in the embodiment. In FIG. 3, the magnetic disk drive (HDD) 32 corresponds to each of magnetic disk drives 32-11 to 32-1n and 32-21 to 32-2n shown in FIG. 1 and magnetic disk drives 32-1 to 32-5 shown in FIG. 2. In the explanation below, read the magnetic disk drive 32 as, for example, any one of magnetic disk drives 32-1 to 32-5, if necessary.

The magnetic disk drive 32 comprises a disk enclosure 36 and a control board 38. The disk enclosure 36 is provided with a spindle motor (SPM) 40. On the rotating shaft of the spindle motor 40, for example, magnetic disks (storage media) 46-1 and 46-2 are mounted. The spindle motor 40 rotates the magnetic disks 46-1 and 46-2 at a constant speed of, for example, 4200 rpm.

The disk enclosure 36 is further provided with a voice coil motor (VCM) 42. The voice coil motor 42 drives a head actuator 44 radially over the magnetic disks 46-1 and 46-2. At the tip of the head actuator 44, heads 48-1 to 48-4 are provided. The head actuator is driven by the voice coil motor 42, thereby positioning the heads 48-1 to 48-4 in a target radial position on the recording surface of each of the magnetic disks 46-1 and 46-2.

Each of the heads 48-1 to 48-4 is a composite head into which a write element and a read element are integrated. A longitudinal-magnetic-recording-type write element or a perpendicular-magnetic-recording-type write element is used as the write element. When each write element of the heads 48-1 to 48-4 is a perpendicular-magnetic-recording-type write element, a vertical storage medium with a recording layer and a soft magnetic backing layer is used for the magnetic disks 46-1 and 46-2. A magnetoresistive element, such as a giant magnetoresistive (GMR) element or a tunneling magnetoresistive (TMR) element, is used as the read element.

The heads 48-1 to 48-4 are connected to a head IC 50 with signal lines. On the basis of a write command or a read command from the disk controller 10 acting as the host device of the magnetic disk drive 32, the head IC 50 selects one of the heads 48-1 to 48-4 in accordance with a head select signal and writes or reads data with the selected head. The head IC 50 comprises a write driver for data writing and a preamplifier for data reading.

The control board 38 is provided with an MPU 52. A volatile memory 56, a program memory 58, and a motor drive controller 60 are connected to a bus 54 of the MPU 52. The volatile memory 56, which is composed of, for example, a random access memory (RAM), stores a control program and control data. The program memory 58, which is composed of, for example, a flash read-only memory (FROM), stores a control program. The motor drive controller 60 controls the voice coil motor 42 and spindle motor 40.

Further connected to the bus 54 of the MPU 52 are an FC interface port 62, a hard disk controller 64, a buffer memory controller 66, and a read channel 70. The hard disk controller 64 includes an FC interface controller 74 configured using, for example, hardware. The buffer memory controller 66 controls the buffer memory 68. The read channel 70 functions as a write encode system and a read decode system. The MPU 52 includes an input/output operation module 72. The input/output operation module 72 is a function module realized by the MPU 52 executing a firmware program.

A control module, such as the MPU 52, FC interface port 62, hard disk controller 64, buffer memory controller 66, or read channel 70, can be configured to be a separate LSI according to the installation area of the control board 38. Furthermore, a plurality of control modules, including, for example, the MPU 52, hard disk controller 64, and read channel 70, can be selected to integrate the selected modules into one LSI.

The magnetic disk drive 32 performs a write operation and a read operation on the basis of a command from the disk controller 10 acting as the host side. A normal operation of the magnetic disk drive 32 will be explained on the assumption that the drive 32 is a conventional magnetic disk drive. First, suppose a write command and write data from the disk controller 10 have been received by the FC interface port 62. Then, the input/output operation module 72 decodes the write command and stores the received write data into the buffer memory 68 as needed. Thereafter, the hard disk controller 64 not only converts the received write data into a predetermined data format but also adds an error correction code (ECC) to the write data converted into the predetermined data format by error correction coding.

The read channel 70, which functions as a write encode system, scrambles the write data which has been converted into the predetermined data format and to which the error correction code has been added. The read channel 70 converts the scrambled write data into run-length-limited (RLL) code.

The read channel 70 performs an operation for write compensation for the write data converted into the RLL code. The write data subjected to the write compensation is output to, for example, the head 48-1 selected by the head IC 50 from the write driver of the head IC 50 and then is written onto magnetic disk 46-1 by the write head of the head 48-1.

At this time, the MPU 52 supplies a head positioning signal to the motor drive controller 60, thereby driving the voice coil motor 42 with the motor drive controller 60. By doing this, the MPU 52 performs not only seek control to move the head to a target track specified by the command but also track following control to position the head moved to the target track on the target track.

Next, suppose the FC interface port 62 has received a read command from the disk controller 10. Then, the input/output operation module 72 of the MPU 52 decodes the read command and causes the head IC 50 to select, for example, the head 48-1. The preamplifier of the head IC 50 amplifies the signal read by the read head of the selected head 48-1 (or the read signal). The amplified read signal is input to the read channel 70. The read channel 70, which functions as a read decode system, decodes the read data by, for example, partial response most likelihood (PRML) detection. The hard disk controller 64 corrects errors in the read data decoded by the read channel 70 by an ECC decoding process. The error-corrected read data is stored temporarily in the buffer memory 68 and then is transmitted to the disk controller 10 by the FC interface port 62.

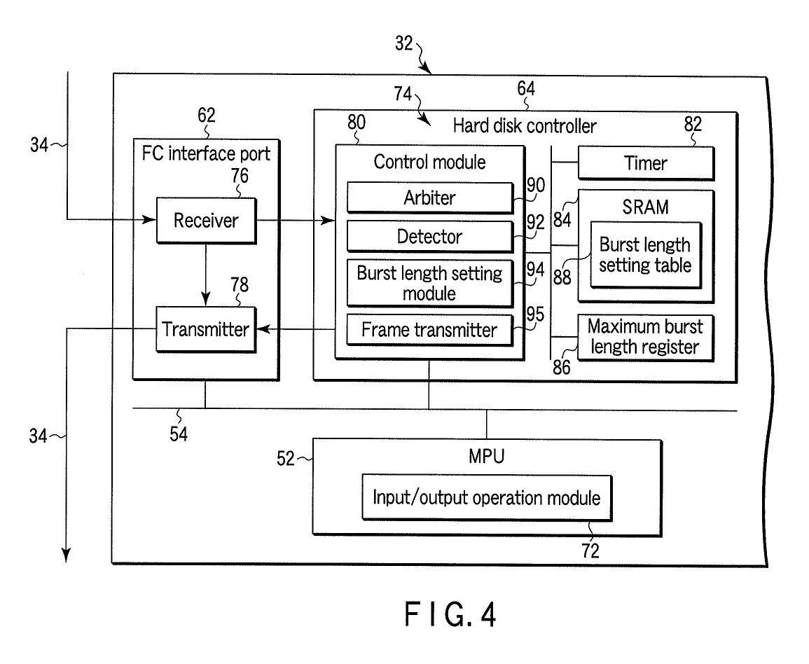

FIG. 4 is a block diagram showing a detailed configuration of the FC interface port 62 and FC interface controller 74 in the magnetic disk drive 32 of FIG. 3. In FIG. 4, the FC interface port 62 comprises a receiver 76 and a transmitter 78. The receiver 76 and transmitter 78, which constitute a port of the FC loop 34, are each connected to the FC loop 34 (more specifically, a fiber cable of the FC loop 34).

The FC interface port 62 complies with PC-PH [Fibre Channel Physical and Signaling Interface] in the ANSI standard configuration concerning FC loops. Accordingly, the FC interface port 62 is composed of FC-0 layer, FC-1 layer, and FC-2 layer. FC-0 layer is physical media which define media type, connector, electric/optical characteristics, and others. FC-1 layer is used for encoding and decoding, such as transmission protocol and 8B/10B decoding. FC-2 layer is used for a framing protocol or a frame building protocol.

The FC interface controller 74 functions as a transmission controller. The FC interface controller 74 comprises a control module 80, a timer 82, a static random access memory (SRAM) 84, and a maximum burst length register 86. The control module 80 comprises an arbiter 90, a detector 92, a burst length setting module 94, and a frame transmitter 95. The SRAM 84 stores a burst length setting table 88 corresponding to the burst length setting module 94. Each of the arbiter 90, detector 92, burst length setting module 94, and frame transmitter 95 is realized in the form of, for example, a hardware circuit composed of a logical LSI.

When, for example, a data transmission request has occurred as a result of the input/output operation module 72 of the MPU 52 having received a command from the host, the arbiter 90 of the control module 80 transmits an arbitration signal to the FC loop 34 via the FC interface port 62, thereby acquiring the right to occupy the FC loop 34 (loop possessory right). Using the timer 82, the detector 92 detects the latency time from when the arbiter 90 transmits an arbitration signal to the FC loop 34 until the arbiter 90 acquires the loop possessory right, as described below.

When the arbiter 90 transmits an arbitration signal to the FC loop 34, the detector 92 starts the timer 82. The detector 92 stops the timer 92 when the arbitration signal transmitted by the arbiter 90 goes along the FC loop 34, returns to the arbiter 90, and is received by the arbiter 90, which then determines that it has acquired the loop possessory right. The detector 92 obtains the operating time of the timer 82 at this time as the latency time. The latency time depends on traffic on the FC loop 34.

The burst length setting module 94 variably sets the burst length of information to be transmitted to the FC loop 34 in accordance with the latency time detected by the detector 92. That is, the burst length setting module 92 sets the burst length variably so that the burst length may be longer as the latency time is shorter and be shorter as the latency time is longer. Specifically, the burst length setting module 94 refers to the burst length setting table 88 stored in the SRAM 84 on the basis of the detected latency time. By doing this, the burst length setting module 94 acquires the burst length corresponding to the detected latency time from the burst length setting table 88 and sets the acquired burst length in the burst length register 86.

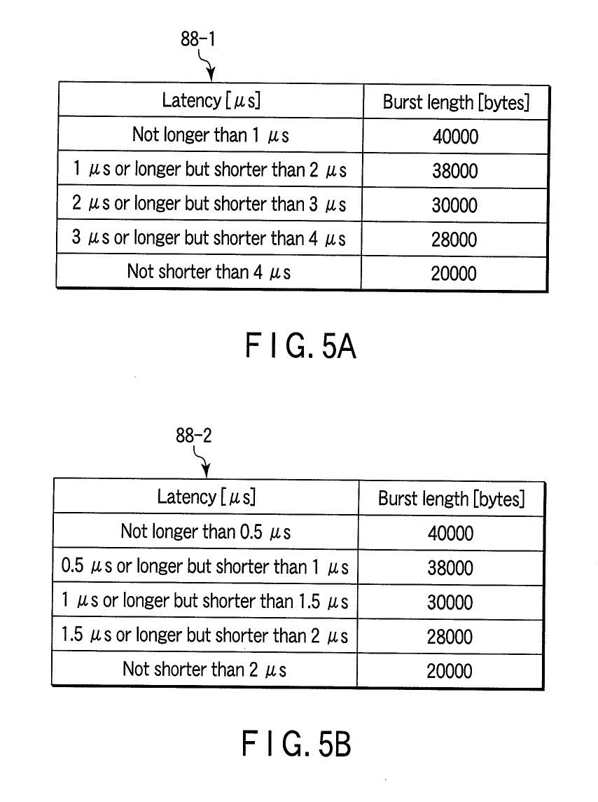

FIGS. 5A and 5B show examples of a burst length setting table applied in the embodiment. FIG. 5A shows a burst length setting table 88-1 in a case where the transmission speed of the FC loop 34 is 1 Gbps. The burst length setting table 88-1 holds 40000 bytes, 38000 bytes, 30000 bytes, 28000 bytes, and 20000 bytes as burst lengths for the respective cases where the latency times are not longer than 1 μs, 1 μs or longer but shorter than 2 μs, 2 μs or longer but shorter than 3 μs, 3 μs or longer but shorter than 4 μs, and not shorter than 4 μs. In the burst length setting table 88-1, the burst length is set so that the burst length may be longer as the latency time is shorter and be shorter as the latency time is longer.

FIG. 5B shows a burst length setting table 88-2 applied in a case where the transmission speed of the FC loop 34 is 2 Gbps. The burst length setting table 88-2 differs from the burst length setting table 88-1 corresponding to 1 Gbps of FIG. 5A in that the latency time halves as compared with that of the latter. The burst length setting tables 88-1 and 88-2 correspond to the burst length setting table 88 shown in FIG. 4.

In FIG. 4, the frame transmitter 95 of the control module 80 generates a data frame with a burst length set in the maximum burst length register 86 by the burst length setting module 94. The frame transmitter 95 transmits the generated data frame to a destination port via the FC loop 34. If the size of information to be transmitted is within the set burst length, one data frame transmission will complete the process. However, if the information to be transmitted is longer than the set burst length, the frame transmitter 95 will divides the information to be transmitted using the set burst length as a unit and transmit the resulting data frames a plurality of times.

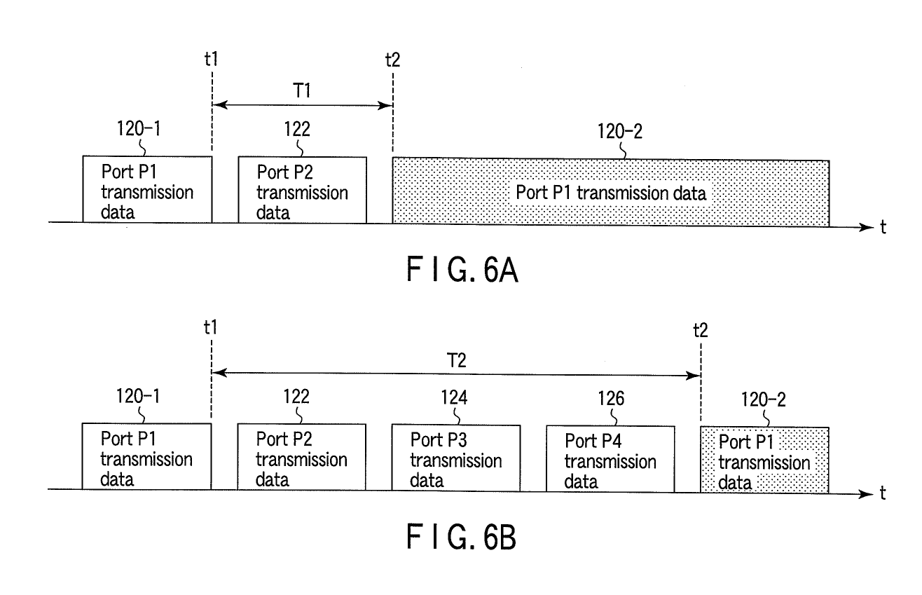

FIGS. 6A and 6B are time charts to explain examples of the relationship between the latency times detected in the embodiment and burst transmissions. Suppose the port of the device interface 26 serving as a host device in the FC loop 34 of FIG. 2 is P0 and the ports of the five magnetic disk drives 32-1 to 32-5 connected to the FC loop 34 are P1 to P5, respectively.

In the FC loop 34 of FIG. 2, suppose, for example, a plurality of command transmission requests have occurred in magnetic disk drive 32-1 with port P1 and, at the same time, a data transmission request has occurred in magnetic disk drive 32-2 with port P2 following port P1. In this case, each of ports P1 and P2 transmits an arbitration signal to the FC loop 34, thereby requesting the right to occupy the FC loop 34 (loop possessory right). As a result, suppose, for example, port P1 which has priority over port P2 acquires the loop possessory right and transmits port P1 transmission data 120-1 to the FC loop 34 as shown FIG. 6A.

Thereafter, the transmission of port P1 transmission data 120-1 is completed at time t1 as shown in FIG. 6A. Then, port P1 transmits a command transmission request for transmitting the next command. That is, port P1 transmits an arbitration signal again to the FC loop 34 to acquire the loop possessory right. At this time, however, port P2 of magnetic disk drive 32-2 also has transmitted an arbitration signal to the FC loop 34 to acquire the loop possessory right. Therefore, according to a fairness algorithm, port P2 acquires the loop possessory right next time and transmits port P2 transmission data 122 as shown in FIG. 6A.

As described above, after having finished transmitting the first port P1 transmission data 120-1 at time t1, port P1 transmits an arbitration signal to the FC loop 34 again. In magnetic disk drive 32-1 which has port P1, the detector 92 of the FC interface controller 74 of FIG. 4 starts the timer 92 at time t1. After the transmission of port P2 transmission data 122 is completed, the loop possessory right is freed. Accordingly, after the transmission of port P2 transmission data 122 is completed, port P1 which sent an arbitration signal at time t1 acquires the loop possessory right at, for example, time t2. When port P1 has acquired the loop possessory right at time t2, the timer of FIG. 4 started at time t1 is stopped by the detector 92. Consequently, it follows that the detector 92 has detected (measured) time T1 from time t1 to time t2, that is, latency time T1, with the timer 82.

Then, in magnetic disk drive 32-1 which has port P1, the burst length setting module 94 of the FC interface controller 74 of FIG. 4 refers to, for example, the burst length setting table 88-1 of FIG. 5A on the basis of latency time T1 detected by the detector 92 using the timer 82. If latency time T1 is as short as 1 μs or less, the burst length setting module 94 sets 40000 bytes, the longest burst length, in the maximum burst length register 86. Then, the frame transmitter 95 of the FC interface controller 74 of FIG. 4 generates a data frame with the burst length set in the maximum burst length register 86, that is, a data frame of 40000 bytes, from time t2 and transmits the generated data frame to the FC loop 34 as port P1 transmission data 120-2 as shown in FIG. 6A.

As described above, in the embodiment, when latency time T1 required to acquire the loop possessory right, the right to occupy the FC loop 34, is short, the burst length setting module 94 sets a long burst length because traffic on the FC loop 34 is light. This enables information to be transmitted at a burst to the destination through the FC loop 34 without dividing the information into short burst lengths.

FIG. 6B is a time chart to explain a case where a data transmission request has occurred at port P1 of magnetic disk drive 32-1 in the FC loop 34 of FIG. 2 and, at the same time, data transmission requests also have occurred at other three magnetic disk drives 32-2, 32-3, and 32-4. In this case, port P1 with the highest priority first acquires the loop possessory right and transmits port P1 transmission data 120-1 as shown in FIG. 6B.

After the transmission of port P1 transmission data 120-1 is completed, port P1 transmits an arbitration signal for acquiring the loop possessory right at time t1 to the FC loop 34 to transmit the next information. At this time, however, ports P2, P3, and P4 of magnetic disk drives 32-2, 32-3, and 32-4 also have transmitted arbitration signals to the FC loop 34. Therefore, according to the fairness algorithm, the FC loop 34 is acquired in this order: ports P2, P3, and P4 which have transmitted arbitration signals to the FC loop 34 at the same time to request data transmission. This causes port P2 transmission data 122, port P3 transmission data 124, and port P4 transmission data 126 to be transmitted in that order.

Thereafter, for example, at time t2 of FIG. 6B, port P1 acquires the loop possessory right requested by the arbitration signal transmitted at time t1. In this case, in magnetic disk drive 32-1 which has port P1, the detector 92 of the FC interface controller 74 detects (measures) time T2 from time t1 to time t2 as latency time with the timer 82.

During the period of latency time T1 detected by magnetic disk drive 32-1 with port P1, loop control is performed by transmission data corresponding to three ports. Accordingly, latency time T2 is equal to or longer than 4 μs shown in, for example, the burst length setting table 88-1 of FIG. 5A. Since latency time T2 is as long as 4 μs or more, the burst length setting module 94 of the FC interface controller 74 has determined that traffic on the FC loop 34 is heavy and sets 20000 bytes, the shortest burst length, in the maximum burst length setting register 86 on the basis of the burst length setting table 88-1. In this case, the frame transmitter 95 of the FC interface controller 74 transmits a data frame with the burst length set in the maximum burst length register 86, that is, a data frame of 20000 bytes, to the FC loop 34 as port P1 transmission data 120-2 as shown in FIG. 6B.

In FIG. 4, the FC interface controller 74 of the embodiment sets a burst length on the basis of the result of detecting the latency time as shown in FIGS. 6A and 6B. Specifically, the FC interface controller 74 adds the function of detecting the latency time and setting the burst length variably on the fibre channel arbitrated loop (FC-AL) defined in the ANSI fibre channel standard.

As shown in FIG. 4, the FC interface controller 74 is included in the hard disk controller 64. The control module 80 of the FC interface controller 74 is realized together with the timer 82, SMRAM 84, and maximum burst length register 86 in the form of a hardware circuit composed of logical LSIs. Accordingly, the control module 80 processes a series of processes at high speeds by hardware. The processes include the acquisition of the loop possessory right at the time of occurrence of a data transmission request, the detection of latency time, the setting of burst lengths, and the transmission of frames.

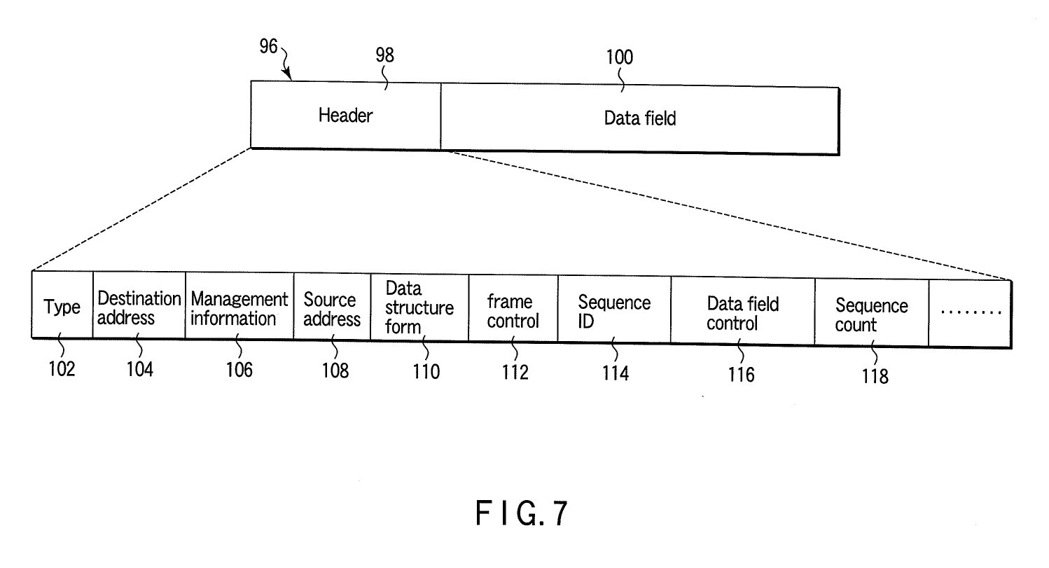

Next, FC-AL in the ANSI fibre channel standard which realizes the FC interface controller 74 of FIG. 4 will be explained. FIG. 7 shows the format of a frame transmitted through the FC loop. In FIG. 7, a frame 96 is composed of a header 98 and a data field 100. The header 98 includes type 102, destination address 104, management information 106, source address 108, data structure form 110, frame control 112, sequence ID 114, data field control 116, and sequence count 118.

Type 102, which is defined as R-CTL [Routing Control], represents the type of a frame, such as a link control frame, a link data frame, or a device data frame. Destination address 104, which is defined as D-ID [Destination Identifier], is the address of the destination of a frame.

Management information 106, which is defined as CS_CTL [Class Specific Control], is management information for service class identified as start-of-frame (SOF). Source address 108, which is defined as S-ID [Source Identifier], is the address of the source of a frame. Data structure form 110, which is defined as TYPE [Data Structure Type], defines a data structure according to the type of a frame.

Frame control 112, which is defined as F-CTL [Frame Control], is used to control the transmission sequence of frames composed of flags and codes. Sequence ID 114, which is defined as SEQ-ID [Sequence Identifier], represents a sequence to which a frame necessary for mixed transmission belongs. Data field control 116, which is defined as DF-CTL [Data Field Control], represents the presence or absence of and the type of a header arbitrarily added to the head of the data field 100. Sequence count 118, which is defined as SEQ-CNT [Sequence Count], represents the order of a frame.

The frame 96 shown in FIG. 7 has a finite length determined by the setting of the burst length. Data is set in the data field 100 of the frame 96 and then transmitted. Therefore, data exceeding the burst length is divided and transmitted. That is, a frame is the smallest unit of data transmission.

In contrast to such a frame, a sequence is a set of frames transmitted in the same direction. Data longer than a frame is divided into a plurality of frames, which are then transmitted. In this case, sequence numbers are set to the individual frames. The sequence numbers represent the order of divided frames. Normally, data transmission corresponding to a read command or a write command in the magnetic disk drive is realized by the transmission of a sequence composed of a plurality of frames.

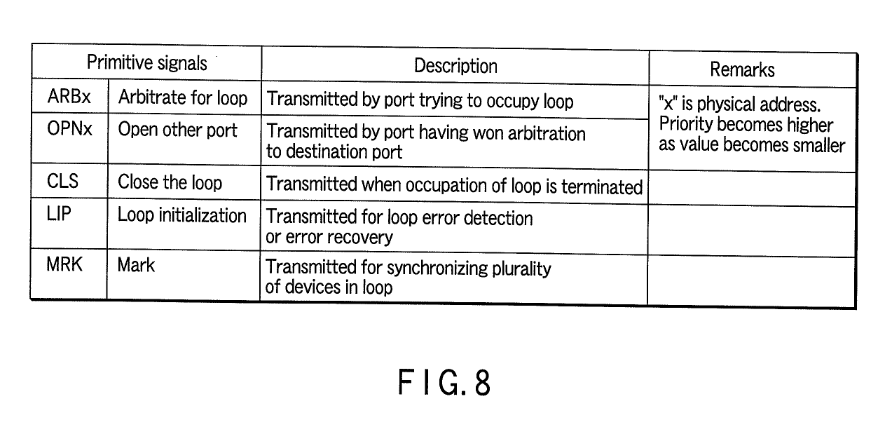

FIG. 8 is a table listing primitive signals on FC-AL used in acquiring and freeing the loop possessory right. In the FC loop of the embodiment, not only the frame 96 with the format of FIG. 7 for exchanging data but also the primitive signals shown in FIG. 8 for acquiring and freeing the loop possessory right, the right to occupy the FC loop, are used.

In the embodiment, as shown in FIG. 8, an ARBx signal, an OPNx signal, a CLS signal, an LIP signal, and an MRK signal are used as the primitive signals. Here, “x” attached to the ARBx signal and OPNx signal represents the physical address of the corresponding port in the FC loop as shown in the remarks of FIG. 8. The smaller the address, the higher the priority of the port.

The ARBx signal is an arbitration signal which is transmitted by a port trying to occupy the FC loop and which is for requesting the acquisition of the loop possessory right. In the explanation below, the request for the acquisition of the loop possessory right may be referred to as the loop acquisition request. The OPNx signal is a signal which is transmitted to a destination port by a port that has acquired the loop possessory right in arbitration by the transmission of the ARBx signal. The OPNx signal is used for a port that has acquired the loop possessory right to establish a point-to-point link with the destination port. The CLS signal is a signal transmitted by the port that has occupied the FC loop to terminate the occupation.

The signals necessary to acquire and free the FC loop are these three signals: ARBx signal, OPNx signal, and CLS signal. On the other hand, the LIP signal is transmitted for loop error detection or error recovery. The MRK signal is transmitted to synchronize a plurality of devices connected to the FC loop, that is, a plurality of devices in the FC loop.

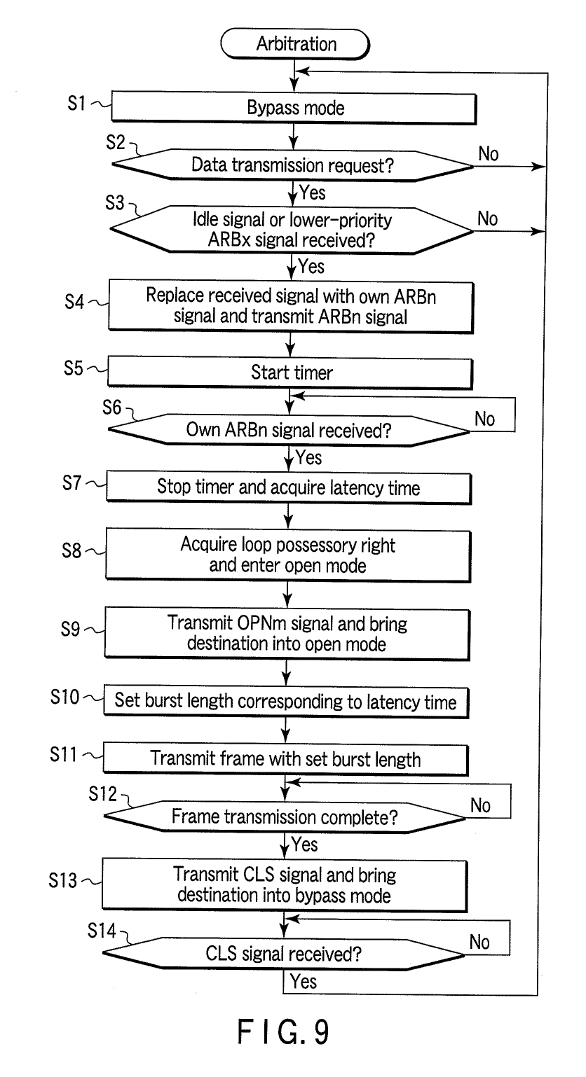

FIG. 9 is a flowchart to explain the procedure for processing arbitration for the FC loop by the FC interface controller 74 applied in the embodiment. Hereinafter, arbitration shown in the flowchart of FIG. 9 will be explained, taking as an example the FC interface controller 74 of magnetic disk drive 32-1 connected to the FC loop 34 of FIG. 2. Here, suppose the physical address of port P1 of magnetic disk drive 32-2 is n and the physical address of port P0 of the device interface 26 serving as the host side is m.

In FIG. 9, suppose magnetic disk drive 32-1 of FIG. 2 is in the idle state. The idle state is a state where there is no data transmission request in magnetic disk drive 32-1. When magnetic disk drive 32-1 is in the idle state, port P1 of magnetic disk drive 32-1 is set in a bypass mode (block S1). That magnetic disk drive 32-1 is in the idle state may be expressed as follows: port P1 is in the idle state. When port P1 of magnetic disk drive 32-1 is set in the bypass mode, the FC interface port 62 of FIG. 4 carries out a bypass operation. In the bypass operation, the signal received by the receiver 76 from the FC loop 34 is transmitted from the transmitter 78 to the FC loop 34 without being modified.

In such a state, suppose a data transmission request has occurred in magnetic disk drive 32-1 (Yes in block S2). Then, the FC interface controller 74 of FIG. 4 proceeds to block S3. In block S3, if the arbiter 90 of the FC interface controller 74 has determined that it has received either an idle signal or a lower-priority ARBx signal (x>n) (Yes in block S3), it proceeds to block S4. Here, the idle signal corresponds to the lowest-priority ARB (F0) signal described later. ARBx signal is an arbitration signal for loop acquisition request which has been transmitted from another port lower in priority than port P1 of magnetic disk drive 32-1.

In block S4, the arbiter 90 replaces the received signal, that is, the idle signal or ARBx signal, with its own ARBn signal higher in priority than the received signal and transmits the ARBn signal from port P1 of magnetic disk drive 32-1 to the FC loop 34. At the same time the ARBn signal is transmitted, the detector 92 of the FC interface controller 74 starts the timer 82 of FIG. 4, thereby starting to detect latency time (block S5).

Here, suppose there is no data transmission request at ports P2 to P5 of magnetic disk drives 32-2 to 32-5 excluding magnetic disk drive 32-1 and port P0 of the device interface 26 and therefore, each of magnetic disk drives 32-2 to 32-5 and device interface 26 is in the idle state. In this case, the ARBn signal transmitted from port P1 of magnetic disk drive 32-1 to the FC loop 34 in block S4 passes through ports P2 to P5 of the other magnetic disk drives 32-2 to 32-5 and port P0 of the device interface 26 sequentially in that order, goes along the FC loop 34, returns to source port P1, and is received by port P1.

Then, the arbiter 90 of magnetic disk drive 32-1 determines that it has received the ARBn signal transmitted by itself from the FC loop 34 (Yes in block S6). In this case, the detector 92 stops the timer 82 and acquires (detects) latency time T (block S7). The arbiter 90 has determined that port P1 has acquired the loop possessory right, on the basis of the reception of the ARBn signal transmitted by itself from the FC loop 34 (block S8). In block S8, the arbiter 90 cancels the bypass mode set in block S1 and brings port P1 into the open mode (that is, the loop open mode).

In the open mode, all the inputs received at port P1 are taken in and the unnecessary signals are discarded at port P1. Accordingly, even if any one of the other ports P2 to P5 and P0 transmits an ARBx signal to the FC loop 34 to request loop acquisition, it will be discarded at port P1 set in the open mode. This prevents the other ports from occupying the FC loop 34 in a state where port P1 has occupied the FC loop 34.

When the arbiter 90 of magnetic disk drive 32-1 has brought port P1 into the open mode, it transmits an OPNm signal from port P1 to port P0 of the device interface 26 with destination physical address m, thereby bringing port P0 into the open mode (block 9). This brings source port P1 and destination port P0 into the open mode. Ports P2 to P5 excluding ports P1 and P0 are in the bypass mode. Accordingly, even if any one of ports P2 to P5 in the bypass mode transmits an ARBx signal for loop occupation, the ARBx signal will be discarded at port P1 or P0 in the open mode. This enables a point-to-point link state to be established between the soured port P1 and destination port P0.

In magnetic disk drive 32-1, the burst length setting module 94 of the FC interface controller 74, on the basis of the latency time acquired in block S7, reads the burst length corresponding to the latency time from the burst length setting table 88 of FIG. 4 and sets the read burst length in the maximum burst length register 86 (block S10). The frame transmitter 95 of the FC interface controller 74 builds a frame as shown in FIG. 7 which has the burst length set in the maximum burst length register 86 and transmits the built frame from port P1 to port P0 via the FC loop 34 (block S11).

Then, the frame transmitter 95 determines whether the frame transmission is terminated (block S12). If information to be transmitted which is specified by a data transmission request is longer than the set burst length, the information to be transmitted is divided using the set burst length as a unit and is transmitted in the form of a plurality of frames. That is, the information to be transmitted is divided and transmitted in a plurality of frame transmissions.

If it has been determined in block S12 that the frame transmission has been completed, the arbiter 90 of magnetic disk drive 32-1 proceeds to block S13. In block S13, the arbiter 90 transmits a CLS signal from port P1 to the FC loop 34. Then, destination port P0 in the open mode receives the CLS signal transmitted from port P1 to the FC loop 34 and changes from the open mode to the bypass mode in accordance with the CLS signal. That is, the FC interface controller 74 transmits the CLS signal from port P1 to the FC loop 34, thereby bringing destination port P0 in the open mode into the bypass mode.

When the CLS signal transmitted from port P1 has made a circuit of the FC loop 34, it is received by port P1. When the arbiter 90 of magnetic disk drive 32-1 has determined that the CLS signal transmitted from port P1 has been received by port P1 (block S14), the arbiter 90 returns to block S1. In block S1, the FC interface controller 74 sets port P1 in the bypass mode again, thereby canceling the point-to-point link state. Then, the arbiter 90 waits for the next data transmission request.

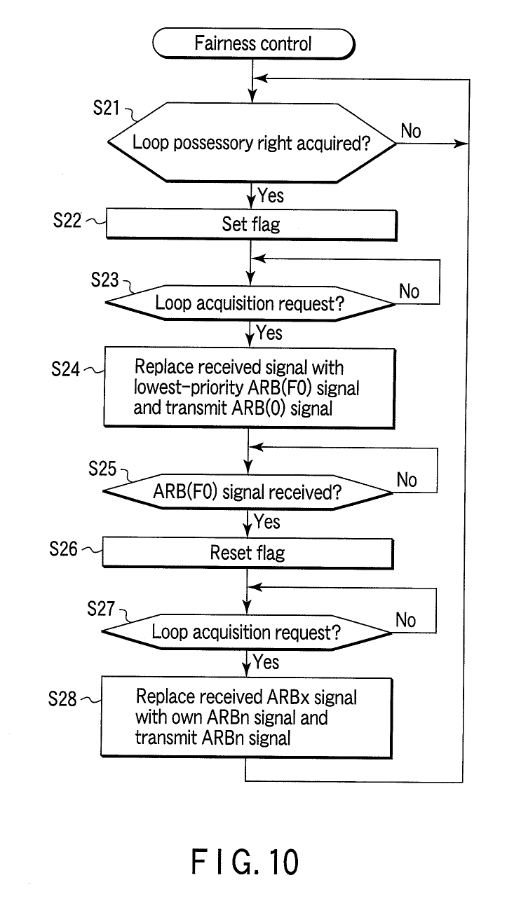

FIG. 10 is a flowchart to explain the procedure for performing fairness control by the FC interface controller 74 applied in the embodiment. The fairness control enables all the ports to occupy the FC loop equally. Hereinafter, the fairness control shown in the flowchart of FIG. 10 will be explained, taking an example the FC interface controller 74 of magnetic disk drive 32-1 connected to the FC loop 34 of FIG. 2.

The FC interface controller 74 of magnetic disk drive 32-1 determines whether port P1 of magnetic disk drive 32-1 has acquired the loop possessory right and changed to the open mode (block S21). If the FC interface controller 74 has determined that it has received its own ARBn signal in block S6 in arbitration shown in the flowchart of FIG. 9 and has acquired the loop possessory right in block S8 of FIG. 9, it determines that port P1 has acquired the loop possessory right and changed to the open mode (Yes in block S21). In this case, the FC interface controller 74 proceeds to block S22 and sets its own flag (in more detail, flag corresponding to port P1). The state where the flag is set is kept even when port P1 is brought back into the bypass mode as a result of the termination of the frame transmission and further returns to the idle state where there is no data transmission request in the bypass mode.

Then, in the idle state, suppose the FC interface controller 74 of magnetic disk drive 32-1 has determined that there has been a loop acquisition request from one other port (Yes in block S23). The loop acquisition request is determined on the basis of the reception of the ARBx signal from the one other port. At this time, the flag corresponding to port P1 the FC interface controller 74 of magnetic disk drive 32-1 has is in the set state. Accordingly, the FC interface controller 74 replaces the ARBx signal received from the one other port with the lowest-priority ARB (F0) signal and transmits the ARB (F0) signal from port P1 to the FC loop 34 (block S24).

As described above, once the flag corresponding to port P1 has been set, port P1 is in the idle state and continues transmitting the lowest-priority ARB (F0) signal (i.e., ARB (F0) signal as an idle signal). Therefore, if a transmission request has occurred at any one (hereinafter, referred to as port Px) of ports P2 to P5 and P0 excluding port P1 (Yes in block S2 of FIG. 9), since the priority of port Px is inevitably higher than the lowest priority (Yes in block S3 of FIG. 9), the ARB (F0) signal is replaced with an ARBx signal whose priority is higher than the lowest one (block S4 of FIG. 9). This enables port Px, or any port other than port P1 corresponding to the set flag to acquire the loop possessory right (block S8 of FIG. 9).

Suppose, after the flag corresponding to port P1 has been set, each of the other ports P2 to P5 and P0 has acquired the loop possessory right sequentially and the flags corresponding to the ports have been set (block S22 of FIG. 10). Then, the lowest-priority ARB (F0) signal transmitted from port 1 bypasses port P2 to P5 and P0 without being replaced at any one of the other ports P2 to P5 and P0, makes a circuit of the FC loop 34, and is received by port P1 again.

Accordingly, if the FC interface controller 74 of magnetic disk drive 32-1 has determined that the ARB (F0) signal transmitted by itself has been received from the FC loop 34 at port P1 (Yes in block S25), the controller 74 resets the flag corresponding to port P1 (block S26). As described above, suppose, after the flag corresponding to port P1 has been reset, the FC interface controller 74 of magnetic disk drive 32-1 has determined as a result of the reception of the ARBx signal that there has been a loop acquisition request from one other port (Yes in block S27). Then, the FC interface controller 74 replaces the received ARBx signal with its own ARBn signal higher in priority and transmits the ARBn signal from port P1 to the FC loop 34 (block 28). This enables arbitration shown in FIG. 9, which allows port 1 to acquire the loop possessory right again.

With the embodiment, all of ports P1 to P5 and P0 carry out the processes following the procedure shown in FIG. 10 described above, thereby realizing fairness control. Specifically, a port which has acquired the loop possessory right once and entered the open mode can be prevented from occupying the FC loop 34 for a predetermined period. The predetermined period is from when all of the other ports which have transmitted ARB signals for loop acquisition requests acquire the loop possessory right and enter the open mode until they set the corresponding flags. This enables all of the ports transmitting ARB signals for loop acquisition requests to occupy the loop equally.

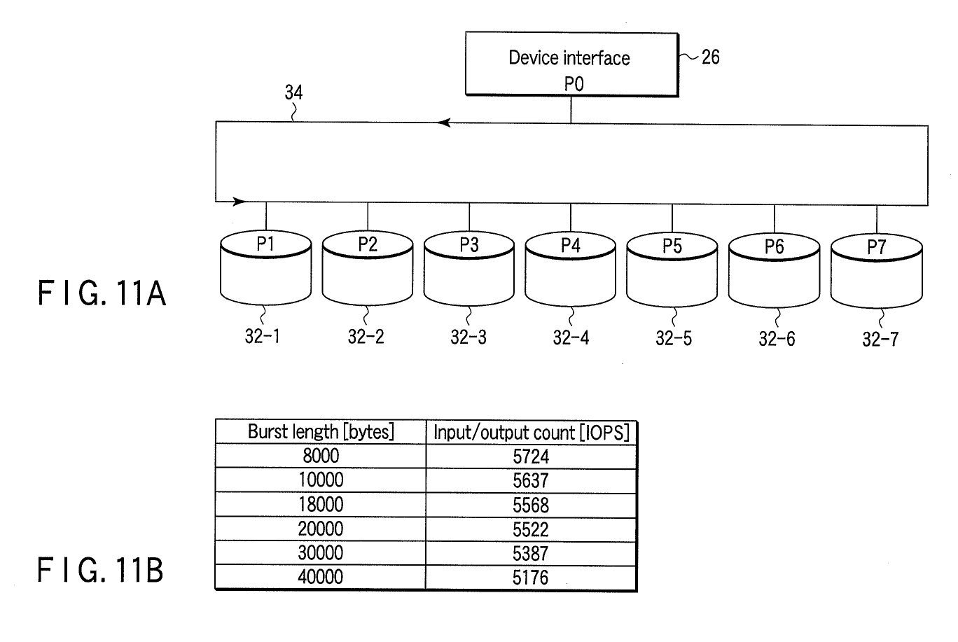

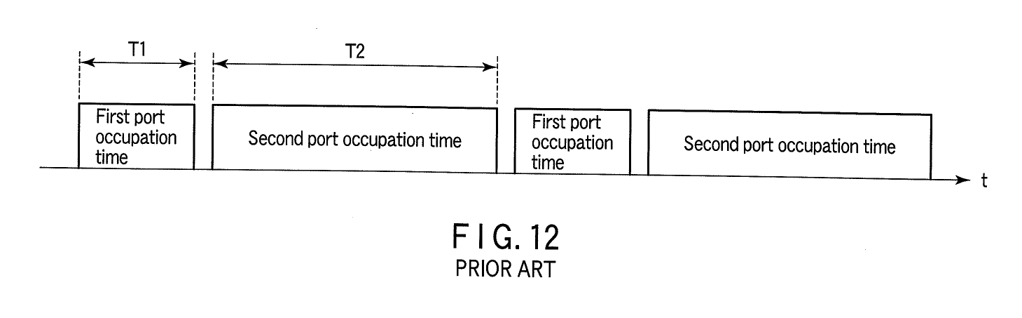

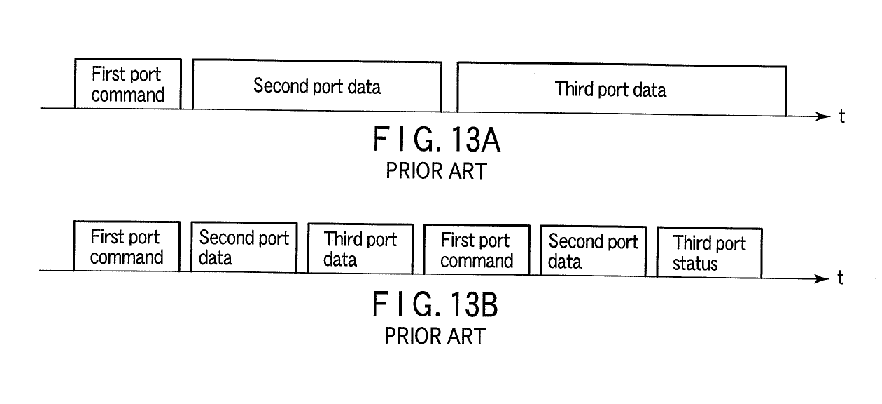

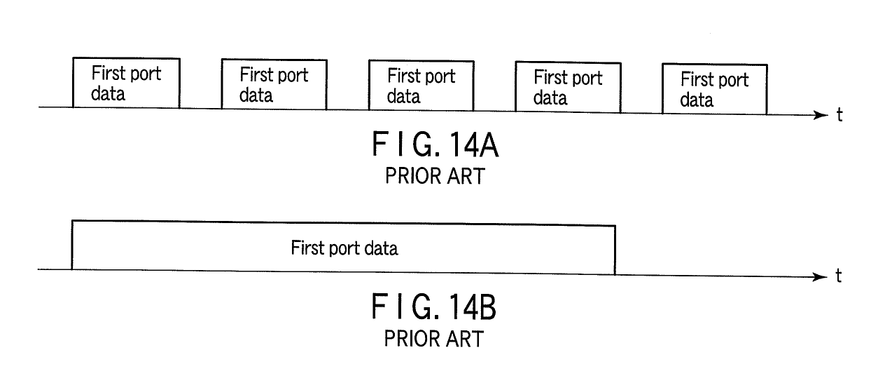

FIGS. 11A and 11B are diagram to explain the evaluation result when the burst length is varied in accordance with the latency time in the embodiment. FIG. 11A shows a schematic configuration of an FC loop which corresponds to FIG. 2 and is to be evaluated. Not only the device interface 26 serving as the host side but also, for example, seven magnetic disk drive 32-1 to 32-7 are connected via ports P1 to P7 to the FC loop 34 shown in FIG. 11A. In FIG. 11A, magnetic disk drive 32-7 corresponds to each of magnetic disk drives 32-1n and 32-2n of FIG. 1.

FIG. 11B shows IOPS [input/output operations per second], the number of inputs and outputs processed in a second by the system, as an example of the evaluation results when the burst length is changed in accordance with latency time for each of the seven magnetic disk drives 32-1 to 32-7 connected to an evaluation FC loop 34 shown in FIG. 11A.

In the evaluation FC loop 34 of FIG. 11A, the device interface 26 issues to, for example, magnetic disk drives 32-1 and 32-2 a read command for such a long burst length as interferes with traffic on the other magnetic disk drive 32-3 to 32-7. In this case, suppose a read command to require the reading of 512 kilobytes of data is issued.

In this state, the device interface 26 issues a large number of read commands to request the reading of data with a short burst length, for example, 2 kilobytes of data, to the five magnetic disk drives 32-3 to 32-7 excluding magnetic disk drives 32-1 and 32-2 so that traffic on the FC loop 34 may become a high load. In this case, suppose 64 2-kilobyte read commands are issued to each of magnetic disk drives 32-3 to 32-7.

In the FC loop 34 on which traffic is a high load, the latency time for the two magnetic disk drives 32-1 and 32-2 transmitting 512 kilobytes of data to acquire the loop possessory right becomes relatively long. In magnetic disk drive 32-1 and 32-2, of the burst lengths shown in FIG. 11B, a shorter burst length of 10000 bytes or 8000 bytes is set as the maximum burst length. As a result, IOPS corresponding to each of 10000 bytes and 8000 bytes is improved in the number of inputs and outputs as shown by 5637 and 5724 in FIG. 11B. It has been confirmed that the system performance has been improved and the throughput of the entire system has been increased.

In the embodiment, the latency time is detected as described above, taking into account the fact that, as the number of ports connected to the FC loop 34 increases, the time from when each port requests the loop possessory right until it acquires the right, that is, the latency time, becomes longer. That is, in the embodiment, since the FC interface controller 74 cannot directly detect how much traffic there is on the FC loop 34, it detects the latency time as information that indirectly represents traffic on the FC loop 34.

When the detected latency time is long, the FC interface controller 74 determines that traffic on the FC loop 34 is heavy, and performs data transmission in a state where the burst length is decreased. In contrast, when the detected latency time is short, the FC interface controller 74 determines that traffic on the FC loop 34 is light, and performs data transmission in a state where the burst length is increased. By doing this, the embodiment enables each port to transmit information with the optimum burst length in accordance with traffic on the FC loop 34, which increases the use efficiency of the FC loop 34. As a result, with the embodiment, the throughput of the entire system where a plurality of magnetic disk drives are connected to the host device in a loop connection manner can be increased.

The fibre channel loop applied in the embodiment is based on a case where it complies with the ANSI fibre channel standard. However, the fibre channel loop does not necessarily conform to the ANSI fibre channel standard.

The various modules of the storage device described herein can be implemented as software applications, hardware and/or software modules. While the various modules are illustrated separately, they may share some or all of the same underlying logical or code.

While certain embodiments of the inventions have been described, these embodiments have been presented by way of example only, and are not intended to limit the scope of the inventions. Indeed, the novel apparatuses and methods described herein may be embodied in a variety of other forms; furthermore, various omissions, substitutions and changes in the form of the apparatuses and methods described herein may be made without departing from spirit of the inventions. The accompanying claims and their equivalents are intended to cover such forms or modifications as would fall within the scope and spirit of the inventions.

What is claimed is:

1. A storage device comprising:
a port configured to transmit data in a first direction of a fiber channel loop;
an arbiter configured to transmit an arbitration signal from the port to the fiber channel loop and to acquire an exclusive access for the fiber channel loop when a data transmission request has occurred at the port;
a detector configured to detect a latency time from when the arbitration signal is transmitted to when the exclusive access is acquired; and
a frame transmitter configured to transmit a frame with a burst length corresponding to the detected latency time from the port to a destination via the fiber channel loop.

2. The storage device of claim 1, wherein the frame transmitter is configured to divide information to be transmitted and to transmit the information in the form of a plurality of frames when the burst length corresponding to the detected latency time is longer than the information to be transmitted identified by the data transmission request.

3. The storage device of claim 1, further comprising a burst length setting module configured to set a burst length corresponding to the detected latency time,
wherein the frame transmitter is configured to transmit a frame with the set burst length as the frame with the burst length corresponding to the detected latency time.

4. The storage device of claim 3, wherein the burst length setting module is configured to adjust the set burst length longer as the latency time is shorter and to adjust the set burst length shorter as the latency time is longer.

5. The storage device of claim 3, further comprising a memory configured to store table information, the table information comprising burst lengths in association with respective predetermined latency time intervals,
wherein the burst length setting module is configured to acquire a burst length corresponding to the detected latency time by referring to the table information based on the detected latency time.

6. The storage device of claim 3, further comprising a memory configured to store table information for a plurality of data transmission speeds, the table information comprising burst lengths in association with respective predetermined latency time intervals,
wherein the burst length setting module is configured to acquire a burst length corresponding to the detected latency time by referring to the table information corresponding to the data transmission speed of the fiber channel loop based on the detected latency time.

7. The storage device of claim 1, wherein the arbiter is configured
to set the port in a bypass mode for transmitting a signal received by the port from the port to the fiber channel loop without being modified in a state where the data transmission request has not occurred,
to replace the signal received by the port when the data transmission request has occurred in the bypass mode with the arbitration signal and to transmit the arbitration signal from the port to the fiber channel loop, the received signal being either an idle signal or a second arbitration signal lower in priority than the arbitration signal,
to acquire the exclusive access as a result of the port having received the arbitration signal transmitted and to change the port from the bypass mode to a loop open mode,
to establish a point-to-point link state between the port and a destination in the loop open mode by setting the destination to the loop open mode, and
to set the destination to the bypass mode when the frame transmission corresponding to the data transmission request has been completed and to set the port to the bypass mode.

8. A transmission controller comprising:
an arbiter configured to transmit an arbitration signal from a port to a fiber channel loop and to acquire an exclusive access for the fiber channel loop when a data transmission request has occurred at the port, the port being connected to the fiber channel loop and being configured to transmit data in a first direction of the fiber channel loop;
a detector configured to detect a latency time from when the arbitration signal is transmitted to when the exclusive access is acquired; and
a frame transmitter configured to transmit a frame with a burst length corresponding to the detected latency time from the port to a destination via the fiber channel loop.

9. The transmission controller of claim 8, wherein the frame transmitter is configured to divide information to be transmitted and to transmit the information in the form of a plurality of frames when the burst length corresponding to the detected latency time is longer than the information to be transmitted identified by the data transmission request.

10. The transmission controller of claim 8, further comprising a burst length setting module configured to set a burst length corresponding to the detected latency time,
wherein the frame transmitter is configured to transmit a frame with the set burst length as the frame with the burst length corresponding to the detected latency time.

11. The transmission controller of claim 10, wherein the burst length setting module is configured to adjust the set burst length longer as the latency time is shorter and to adjust the set burst length shorter as the latency time is longer.

12. The transmission controller of claim 10, further comprising a memory configured to store table information, the table information comprising burst lengths in association with respective predetermined latency time intervals,
wherein the burst length setting module is configured to acquire a burst length corresponding to the detected latency time by referring to the table information based on the detected latency time.

13. The transmission controller of claim 10, further comprising a memory configured to store table information for a plurality of data transmission speeds, the table information holding burst lengths in association with predetermined latency time intervals,
wherein the burst length setting module is configured to acquire a burst length corresponding to the detected latency time by referring to the table information corresponding to the data transmission speed of the fiber channel loop based on the detected latency time.

14. The transmission controller of claim 8, wherein the arbiter is configured
to set the port in a bypass mode for transmitting a signal received by the port from the port to the fiber channel loop without being modified in a state where the data transmission request has not occurred,
to replace the signal received by the port when the data transmission request has occurred in the bypass mode with the arbitration signal and to transmit the arbitration signal from the port to the fiber channel loop, the received signal being either an idle signal or a second arbitration signal lower in priority than the arbitration signal,
to acquire the exclusive access as a result of the port having received the arbitration signal transmitted and to change the port from the bypass mode to a loop open mode,
to establish a point-to-point link state between the port and a destination in the loop open mode by setting the destination to the loop open mode, and
to set the destination to the bypass mode when the frame transmission corresponding to the data transmission request has been completed and to set the port to the bypass mode.

15. A method of transmitting data from a port in a first direction of a fibre channel loop in a storage device, the method comprising:
transmitting an arbitration signal from the port to the fiber channel loop acquiring an exclusive access for the fibre channel loop;
detecting a latency time from when the arbitration signal is transmitted to when the exclusive access is acquired; and
transmitting a frame with a burst length corresponding to the detected latency time from the port to a destination via the fiber channel loop.

16. The method of claim 15, further comprising setting a burst length corresponding to the detected latency time,
wherein a frame with the set burst length is transmitted as the frame with the burst length corresponding to the detected latency time.

17. The method of claim 16, further comprising adjusting the set burst length longer as the latency time is shorter and adjusting the set burst length shorter as the latency time is longer.

18. The method of claim 16, wherein a burst length corresponding to the detected latency time is acquired by referring to table information in a memory, the table information comprising burst lengths in association with respective predetermined latency time intervals.

19. The method of claim 16, wherein the burst length corresponding to the detected latency time is acquired by referring to the detected latency time corresponding to the transmission speed of the fiber channel loop of tables in the memory in order to correspond to a plurality of data transmission speeds in a one-to-one correspondence, the tables comprising burst lengths in association with respective predetermined latency time intervals.

20. The method of claim 15, wherein a signal received by the port is replaced with an arbitration signal and the arbitration signal is transmitted when the signal is received by the port in a state where the port has been set in a bypass mode for transmitting the signal received by the port from the port to the fiber channel loop without being modified and where the data transmission request has occurred at the port, the received signal being either an idle signal or a second arbitration signal lower in priority than the arbitration signal, and
the method further comprising:
acquiring the exclusive access as a result of the port having received the arbitration signal transmitted and changing the port from the bypass mode to a loop open mode;
establishing a point-to-point link state between the port and a destination in the loop open mode by setting the destination to the loop open mode, and
setting the destination to the bypass mode when the frame transmission corresponding to the data transmission request has been completed and setting the port to the bypass mode.
